(19) United States
(12) Patent Application Publication
(10) Pub. No.: US 2025/0296466 A1
(43) Pub. Date: Sep. 25, 2025

(54) ELECTRIC VEHICLE CHARGER AND PAYMENT MANAGEMENT SYSTEM FOR THE SAME

(71) Applicant: Wayne Fueling Systems LLC, Austin, TX (US)

(72) Inventors: Aneesh Maria Stephen, Tamil Nadu (IN); Kishore Kumar Govindaswamy, Bangalore (IN); Randal Scott Kretzler, Austin, TX (US); Daniel Jeremy Holmes, Round Rock, TX (US); Mackenzie Graham Thatcher, Round Rock, TX (US); Giovanny Diaz, Austin, TX (US); Jeffrey Thomas Reiter, Austin, TX (US); Jaya Dwivedi, Austin, TX (US); Harish Veeravalli, Austin, TX (US); Baolin Li, Leander, TX (US); Siddharth Jayachandra Babu, Austin, TX (US); Anil Peddireddy, Plainfield, IL (US); Kausheel Kolar Venu, Bangalore (IN)

(21) Appl. No.: 19/090,120

(22) Filed: Mar. 25, 2025

(30) Foreign Application Priority Data
Mar. 25, 2024 (IN) 202411023326

(51) Int. Cl. B60L 53/66; B60L 53/18; G06Q 20/20; G06Q 20/40; G06Q 30/0226; G06Q 50/06

(52) U.S. Cl. CPC B60L 53/665; B60L 53/18; G06Q 20/20; G06Q 20/40; G06Q 30/0233; G06Q 50/06

(57) ABSTRACT

Various exemplary devices, systems, and methods relating to a payment management system for an electric vehicle (EV) charging station are provided. In general, an EV charging station controller is configured to control an operation of the EV charging station and initiate an EV charging transaction upon receiving an indication of approval of payment for delivery of electrical charge from the EV charging station using a credit card or a debit card via a point-of-sale (POS) terminal. In another embodiment, the EV charging station controller is configured to initiate an EV charging transaction upon receiving an indication of approval of payment for delivery of electrical charge from the EV charging station using a loyalty card via the POS terminal. The loyalty card can be associated with customer payment information locally stored in a database of the EV charging station.

### CROSS-REFERENCE TO RELATED APPLICATION

The present application claims priority to Indian patent application Ser. No. 20/241,1023326, filed on Mar. 25, 2024, the entire contents of which are hereby incorporated by reference.

### FIELD

The present disclosure relates to an electric vehicle charging station and a payment management system for the same.

### BACKGROUND

Many existing publicly available electric vehicle (EV) charging stations require proprietary forms of payment from the customer for delivery of electricity from the station. These payment forms often include, for example, payment through a mobile app specifically programmed to communicate with the charging station. While these methods of payment suffice for a subset of customers who are often somewhat tech-savvy, other customers may not have the understanding required to set-up payment through the mobile app, or simply may not be comfortable with associating their bank account or credit card with an app. Accordingly, there is a need for enabling traditional payment methods, such as credit or debit cards, to be used in the context of EV charging transactions.

### SUMMARY

In general, devices, systems, and methods for implementing a payment management system for an EV charging station are provided.

In one aspect, a method is provided that in one implementation includes determining, by an electric vehicle (EV) charging station controller, that a charging cable of an EV charging station is plugged into an EV, the EV charging station controller being configured to control an operation of the EV charging station. The method also includes initiating, at the EV charging station controller, an EV charging transaction upon receiving an indication of approval of payment for delivery of electrical charge from the EV charging station using a credit card or a debit card via a point-of-sale (POS) terminal. The POS terminal can be operably coupled to the EV charging station, and the approval of the payment can be provided at least in part by a financial services provider associated with the credit card or the debit card used for payment via the POS terminal. The method further includes authorizing, by the EV charging station controller, the delivery of electrical charge from the EV charging station, causing the EV charging station to activate delivery electrical charge to the EV, in response to receiving the indication of the approval of payment. The method further includes causing, by the EV charging station controller, the EV charging station to deactivate the delivery of electrical charge to the EV when the EV charging transaction is complete.

In some embodiments, the EV charging station controller can be further configured to control the operation of the EV charging station via an EV charging station application programming interface (API) platform. The method can further include sending, by the EV charging station controller and to the EV charging station API platform, one or more control commands for controlling the operation of the EV charging station via an EV charger API. The EV charging station API platform can provide control commands corresponding to the one or more control commands to the EV charging station, such that the EV charging station controller controls the operation of the EV charging station.

In further embodiments, the initiating of the EV charging transaction can include receiving, at the EV charging station controller, the indication of approval of payment for delivery of electrical charge from the POS terminal.

In yet further embodiments, the EV charging station controller can be configured to communicate with the POS terminal via a POS terminal plugin that is programmed to communicate using a protocol utilized by the POS terminal. The method can further include, upon authorizing the delivery of electrical charge, sending, by the EV charging station controller and to the POS terminal plugin, a notification indicating that electrical charge is being delivered to the EV by the EV charging station. Additionally, the method can further include, upon causing the EV charging station to deactivate the delivery of electrical charge, sending, by the EV charging station controller and to the POS terminal plugin, a notification indicating that the delivery of electrical charge to the EV by the EV charging station is finished. Furthermore, the method can further include, upon causing the EV charging station to deactivate the delivery of electrical charge, sending, by the EV charging station controller and to the POS terminal plugin, data relating to the EV charging transaction indicative of the electrical charge delivered and payment information. The POS terminal plugin can be configured to finalize the EV charging transaction with the financial services provider using the payment information. Also, the method can further include receiving, at the EV charging station controller, a notification that the EV charging transaction has been finalized from the POS terminal plugin.

In even further embodiments, the EV charging station controller can be configured to communicate with the EV charging station via an EV charging station API platform that is programmed to communicate using a protocol utilized by the EV charging station. The authorizing of the delivery of electrical charge can include transmitting, by the EV charging station controller and to the EV charging station, an authorization command via the EV charging station API platform, wherein the authorization command comprises information indicative of vehicle identification, state-of-charge data, and payment credentials. Additionally, the method can further include receiving, at the EV charging station controller and from the EV charging station, a notification that the EV charging station is delivering electrical charge to the EV via the EV charging station API platform. Furthermore, the method can further include monitoring, by the EV charging station controller, the EV charging transaction based on real-time updates regarding the delivery of electrical charge to the EV by the EV charging station received from the EV charging station API platform. Also, the method can further include causing, by the EV charging station controller, information regarding the EV charging transaction to be displayed via a display module operatively coupled to the EV charging station based on the real-time updates received from the EV charging station API platform.

In further embodiments, the EV charging station controller can be configured to communicate with the EV charging station and the EV via a standardized communication protocol. The method can further include establishing, by the EV charging station controller and via the standardized communication protocol, a charging and discharging schedule for the EV and the EV charging station, causing energy flow parameters to be securely exchanged between the EV and the EV charging station. The EV charging station can deliver electrical charge to the EV during one or more charging periods of the charging and discharging schedule, and the EV returns electrical charge to the grid during one or more discharging periods of the charging and discharging schedule.

In another aspect, an electric vehicle (EV) charging station is provided that in one implementation includes an EV charging station controller configured to control operation of the EV charging station; a database configured to store EV charging transaction information; a display module operably coupled to the EV charging station controller and configured to display multimedia content; one or more charging cables and one or more connectors corresponding to the one or more charging cables configured to deliver electrical charge; and a point-of-sale (POS) terminal operably coupled to the EV charging station controller and configured to accept payment of a credit card or a debit card. According to some implementations, the EV charging station controller can be further configured to determine that a charging cable of the one or more charging cables is plugged into an EV; initiate an EV charging transaction upon receiving an indication of approval of payment for delivery of electrical charge from the EV charging station using a credit card or a debit card via the POS terminal; in response to receiving the indication of the approval of payment, authorize the delivery of electrical charge from the EV charging station, causing the EV charging station to activate delivery electrical charge to the EV; and cause the EV charging station to deactivate the delivery of electrical charge to the EV when the EV charging transaction is complete. The approval of the payment can be provided at least in part by a financial services provider associated with the credit card or the debit card used for payment via the POS terminal.

In yet another aspect, a method is provided that in one implementation includes determining, by an electric vehicle (EV) charging station controller, that a charging cable of an EV charging station is plugged into an EV, the EV charging station controller being configured to control an operation of the EV charging station. The method also includes initiating, at the EV charging station controller, an EV charging transaction upon receiving an indication of approval of payment for delivery of electrical charge from the EV charging station using a credit card or a debit card via a point-of-sale (POS) terminal. The POS terminal can be operably coupled to the EV charging station, the loyalty card can be associated with customer payment information locally stored in a database of the EV charging station, and the approval of the payment can be performed by the EV charging station based on the locally stored customer payment information. The method further includes authorizing, by the EV charging station controller, the delivery of electrical charge from the EV charging station, causing the EV charging station to activate delivery electrical charge to the EV, in response to receiving the indication of the approval of payment. The method further includes causing, by the EV charging station controller, the EV charging station to deactivate the delivery of electrical charge to the EV when the EV charging transaction is complete.

In still yet another aspect, an electric vehicle (EV) charging station is provided that in one implementation includes an EV charging station controller configured to control operation of the EV charging station; a database configured to store EV charging transaction information and customer payment information; a display module operably coupled to the EV charging station controller and configured to display multimedia content; one or more charging cables and one or more connectors corresponding to the one or more charging cables configured to deliver electrical charge; and a point-of-sale (POS) terminal operably coupled to the EV charging station controller and configured to accept payment of a loyalty card. The loyalty card can be associated with the customer payment information locally stored in the database. According to some implementations, the EV charging station controller can be further configured to determine that a charging cable of the one or more charging cables is plugged into an EV; initiate an EV charging transaction upon receiving an indication of approval of payment for delivery of electrical charge from the EV charging station using the loyalty card via the POS terminal; in response to receiving the indication of the approval of payment, authorize the delivery of electrical charge from the EV charging station, causing the EV charging station to activate delivery electrical charge to the EV; and cause the EV charging station to deactivate the delivery of electrical charge to the EV when the EV charging transaction is complete. The approval of the payment can be performed by the EV charging station based on the locally stored customer payment information.

### BRIEF DESCRIPTION OF DRAWINGS

The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a schematic view of one implementation of a payment management system for an electric vehicle charging station;

FIG. 2A is a perspective view of one implementation of the electric vehicle charging station of FIG. 1;

FIGS. 2B and 2C are front views of one implementation of the electric vehicle charging station of FIG. 1;

FIG. 2D is a side view of one implementation of the electric vehicle charging station of FIG. 1;

FIG. 2E is a front view of one implementation of the electric vehicle charging station of FIG. 1 with a door opened;

FIG. 2F is a side view of one implementation of the electric vehicle charging station of FIG. 1 with a door opened and a back panel removed;

FIG. 2G is a front view of one implementation of the electric vehicle charging station of FIG. 1 with a door and guard panels removed;

FIG. 2H is another perspective view of one implementation of the electric vehicle charging station of FIG. 1;

FIG. 3 is a schematic view of one implementation of the electric vehicle charging station of FIG. 1;

FIG. 4A is a front view of one implementation of the power cabinet of FIG. 1;

FIG. 4B is a side view of one implementation of the power cabinet of FIG. 1;

FIG. 4C is a top view of one implementation of the power cabinet of FIG. 1;

FIG. 4D is a top view of one implementation of the power cabinet of FIG. 1 with doors opened;

FIGS. 5A and 5B illustrate a first implementation of a process for implementing the payment management system of FIG. 1 using a credit or debit card; and

FIGS. 6A-6C illustrate a second implementation of a process for implementing the payment management system of FIG. 1 using locally stored payment information.

### DETAILED DESCRIPTION

Certain exemplary embodiments will now be described to provide an overall understanding of the principles of the structure, function, manufacture, and use of the devices, systems, and methods disclosed herein. One or more examples of these embodiments are illustrated in the accompanying drawings.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the dimensions of the subject in which the systems and devices will be used, the size and shape of components with which the systems and devices will be used, and the methods with which the systems and devices will be used.

Various exemplary devices, systems, and methods relating to a payment management system for an electric vehicle (EV) charging station are provided. In general, EV charging stations are configured to pull an electrical current (e.g., from a power cabinet, the power grid, a 240V outlet, etc.) and deliver electricity to an EV, which is used by the EV to charge one or more of its batteries. Upon plugging one of the charging station's charging cables into the EV, electricity can be provided to the EV via the cable.

Many publicly available EV charging stations require proprietary forms of payment from the customer for delivery of electricity. These payment forms often include, for example, payment through a mobile app specifically programmed to communicate with the charging station. While these methods of payment suffice for a subset of customers who are often somewhat tech-savvy, other customers may not have the understanding required to set-up payment through the mobile app, or simply may not be comfortable with associating their bank account or credit card with an app.

In an exemplary embodiment, a payment management system is provided which allows EV customers to use traditional payment methods, such as credit or debit cards, for the purpose of an EV charging transaction. Thus, instead of requiring payment through a proprietary mobile app, for example, an EV owner can simply pay for an EV charging transaction at an EV charging station using a credit card. In one implementation, the payment management system provides an EV charging station with a point-of-sale terminal configured to accept various types of payment, such as credit or debit card payment, mobile payment, and/or other forms of contactless payment (e.g., RFID, NFC, etc.). In further implementations, the payment management system allows for a customer to pay for an EV charging transaction using locally stored payment information associated with a customer profile, eliminating the need for a remote financial services provider to authorize a payment transaction. Additionally, the payment management system can support ISO 15118 to enable secure, automated authentication and payment directly between an EV and an EV charging station without requiring manual input. In yet further implementations, an EV charging station integrates a point-of-sale terminal and fueling platform, amounting to an all-in-one EV charging platform.

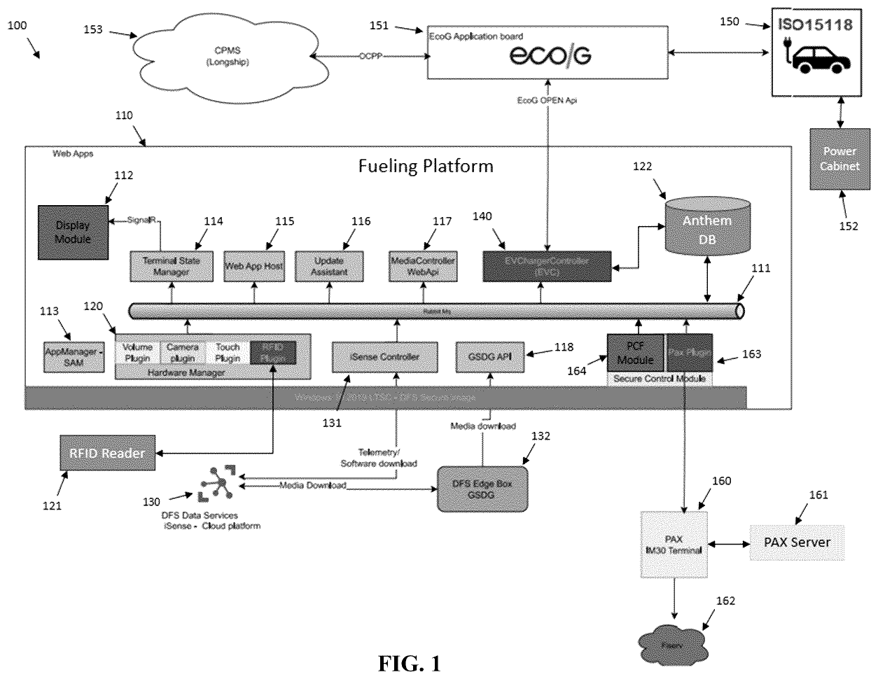

FIG. 1 illustrates one embodiment of a payment management system 100 for an electric vehicle charging station. As shown in FIG. 1, the payment management system 100 can include various interconnected components at the core of which is a fueling platform 110, such as the DFS Anthem UX™ platform owned by Wayne Fueling Systems. The fueling platform 110 can have various configurations. In general, the fueling platform 110 can implement a user experience for a customer during fueling through the integration of a wide range of components with different functionalities including, for example, media displays, input/output modules for customer interaction, security plugins, payment modules, internal and external communication devices, and so on, as described in further detail herein. The fueling platform 110 can be configured to interface with the customer during fueling via various input controls (e.g., buttons, touchscreen controls, etc.) and content displays (e.g., multimedia videos, advertisements, etc.), allowing the customer to generally control the fueling experience, and furthermore can enable the retailer to monitor and measure various performance metrics during operation.

For the purposes of the present disclosure, fueling platform 110 is configured to interface with an electric vehicle (EV) charging station 150 configured to supply electricity to an EV, such that the fueling platform 110 can control an operation of the EV charging station 150, e.g., causing the EV charging station 150 to electrically charge an EV, to discontinue electric charging of the EV, to moderate a rate of electric charging, and so forth. The EV charging station 150 will be described in further detail below. In other implementations, the fueling platform 110 can be coupled to one or more fuel dispensers configured to dispense fuel, such as petroleum-based fuels (gasoline), natural gas, ethanol, butanol, methanol, hydrogen fuel, synthetic fuels, etc.), or alternatively, non-fuels such as goods and services, or a combination of both.

The fueling platform 110 can include a hardware manager module 120 that comprises a variety of software plugins for interfacing with input/output devices, such as volume controls for audio speakers, touch-sensitive sensors for buttons, a touchscreen, or the like, and a camera for recording images/videos of the surrounding area. Furthermore, the hardware manager module 120 can include a radio frequency identification (RFID) plugin for interfacing with an RFID reader 121. The RFID reader 121 can, in some implementations, be configured to read a loyalty card associated with a customer profile managed and/or stored by the fueling platform 110, allowing the customer to pay for electricity supplied from the EV charging station 150 using stored payment information associated with the customer profile. The customer profile information can be stored locally in the fueling platform database 122 or remotely in the cloud, e.g., central server 130 which generally provides data services for and supervisory control of the fueling platform 110. The fueling platform 110 can be configured to communicate directly with the central server 130 via a server controller module 131, which can in turn transmit any received information to the EV charging station controller 140 as needed via message bus 111. In some instances, the central server 130 can provide software/firmware updates to the fueling platform 110, exchange telemetry data with the fueling platform 110, and so forth.

In some implementations, a customer profile can be created by the customer using an app (not shown) designed to interface directly with the fueling platform 110, or in other implementations, via a webpage associated with the fueling platform 110, or any using any other suitable method as would be appreciated by a person of ordinary skill in the art. The customer profile can encompass any variety of information. For example, such information can include, but is not limited to, customer identifying information such as a name, an address, a phone number, an email address, and so on, customer login information such as a username, a password, a security question/answer pair, and so on, payment information such as a bank account number, a credit card number, online payment account information, and so on, etc. In cases where the customer profile encompasses payment information, the customer can effect payment for dispensed electricity using his or her associated customer profile. In some embodiments, the customer can possess an RFID card associated with the customer profile that can be read by the RFID reader 121, and RFID information can in turn be provided to the hardware manager module 120 via the RFID plugin. In other cases, the customer can input his or her identifying information (e.g., username and password) directly to the fueling platform 110, e.g., via a touchscreen as recognized by the touch plugin of the hardware manager module 120, via the customer app which can communicate with an app manager module 113 of the fueling platform 110 using a short-range wireless communication protocol (e.g., a Bluetooth protocol, a Wi-Fi protocol, a near field communication (NFC) protocol, an ultra-wideband (UWB) protocol, an RFID protocol, etc.), for example, or via any other suitable means. Other methods of payment for dispensed electricity, including credit/debit cards, are also envisioned (e.g., via the POS terminal 160) and described below.

In some implementations, the fueling platform 110 can further include any number of additional modules for controlling aspects of the fueling platform 110 such as a terminal state manager module 114 configured for communication with the customer app, a web app host module 115, an update assistant module 116, a media controller web API module 117, and so on. It is to be understood that these modules are merely described as illustrative and should not be treated as limiting the scope of the present disclosure. Similarly, the fueling platform 110 can further include an external media API module 118 configured for communication with a cloud-based media provider 132. The remotely located media provider 132 can be in communication with the central server 130 such that media content can be communicated between them. Furthermore, the media provider 132 can provide media content (e.g., advertisement content, entertainment content, etc.) directly for download to the fueling platform 110 via the external media API module 118.

The multimedia content can be displayed via the display module 112 of the fueling platform 110. The display module 112 can be configured to display such content, as well as any other suitable information such as real-time fueling information, weather information, date/time information, news content, entertainment content, advertisement content, and so on. The display module 112 can have any of a variety of configurations, such as a cathode ray tube (CRT) screen, a liquid crystal display (LCD) screen, a light emitting diode (LED) screen, a touchscreen, and the like. Furthermore, the display module 112 can include any number and/or arrangement of displays, consistent with the scope of the present claims.

The fueling platform 110 can further include an EV charging station controller 140 that is configured to control an operation of the EV charging station 150, by causing the EV charging station 150 to activate or deactivate electric charging, to control the amount or rate of electric charging, and so forth. In some implementations, the EV charging station controller 140 can refer to a hardware device that includes a processor operably coupled to a memory (e.g., fueling platform database 122). The memory can be configured to store program instructions, and the processor can be specifically programmed to execute the program instructions to perform one or more processes for carrying out a payment management system which is described further below. Moreover, it is understood that the following processes may be executed by a system comprising the EV charging station controller 140 in conjunction with one or more additional components, as described in detail below.

In addition, the EV charging station controller 140 of the fueling platform 110 can be embodied as non-transitory computer readable media on a computer-readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards, and optical data storage devices. The computer-readable recording medium can also be distributed in network coupled computer systems so that the computer readable media is stored and executed in a distributed fashion, e.g., by a telematics server or a Controller Area Network (CAN).

Further, the EV charging station controller 140 can support ISO 15118, a standardized communication protocol for secure bi-directional data exchange between an EV and the EV charging station 150. In some implementations, the EV charging station controller 140 can have a “Plug & Charge” functionality which allows the vehicle owner to initiate and authenticate a charging session automatically using digital signatures and certificate-based authentication, instead of manual user input or third-party mobile applications. ISO 15118 can be implemented as part of the communication stack within the EV charging station controller 140 and can operate, for example, over a Power Line Communication (PLC) link established between an EV and the EV charging station 150. Through this link, the EV charging station controller 140 can exchange vehicle identification, state-of-charge data, and payment credentials with the EV in a structured, machine-readable format. It should be understood that ISO 15118 supports both contact-based and ad-hoc payment methods, where an EV can either authenticate using pre-stored credentials or dynamically negotiate payment details during the charging session.

The EV charging station 150, also known as an electric vehicle supply equipment (EVSE), can be a known charging station or dock for providing electric power to an EV so that one or more batteries of the EV can be recharged. The EV charging station 150 can encompass all electrical conductors, related equipment, software, and/or communications protocols necessary to deliver energy to EV, as would be appreciated by a person of ordinary skill in the art. As such, the fueling platform 110 can be configured to interface with and control the operation of existing EV chargers via the EV charging station controller 140. This advantageously allows the fueling platform 110 to have interoperability with existing EV charging infrastructure.

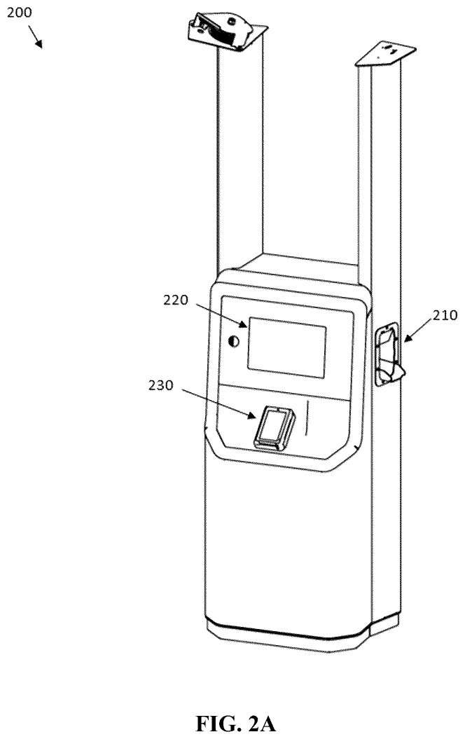

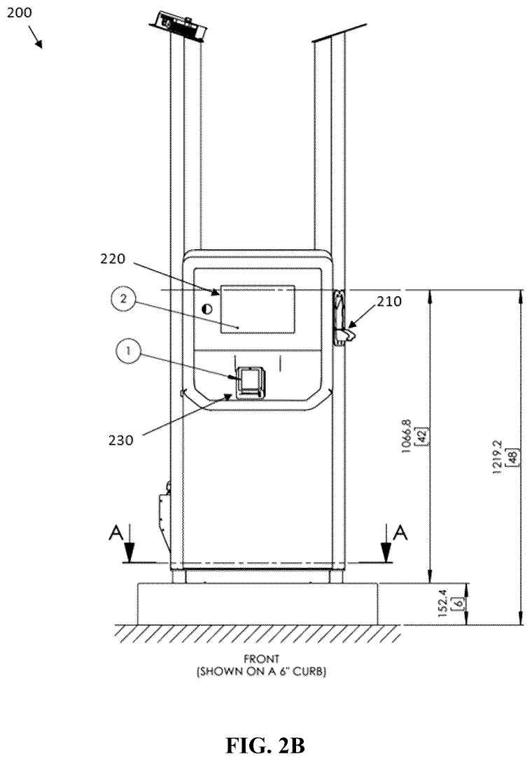

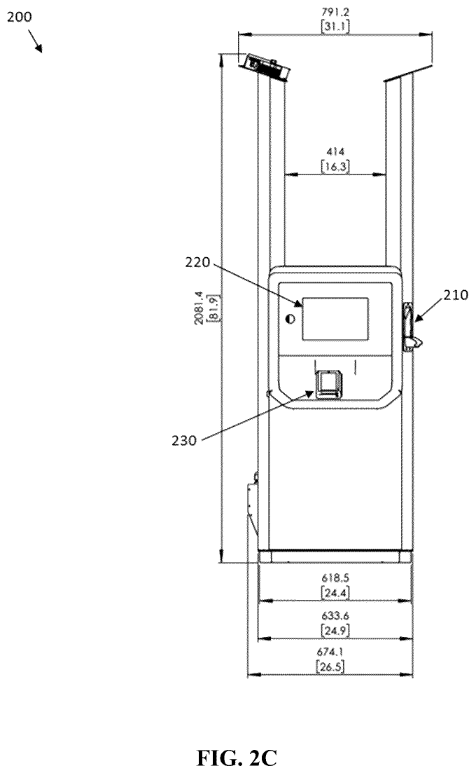

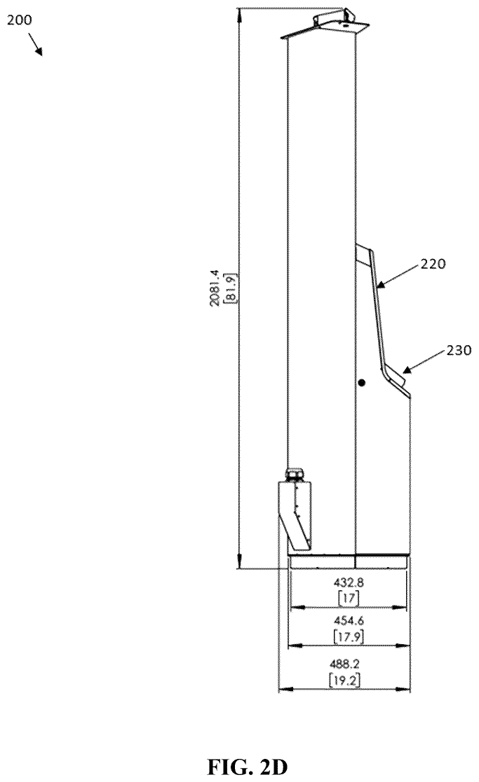

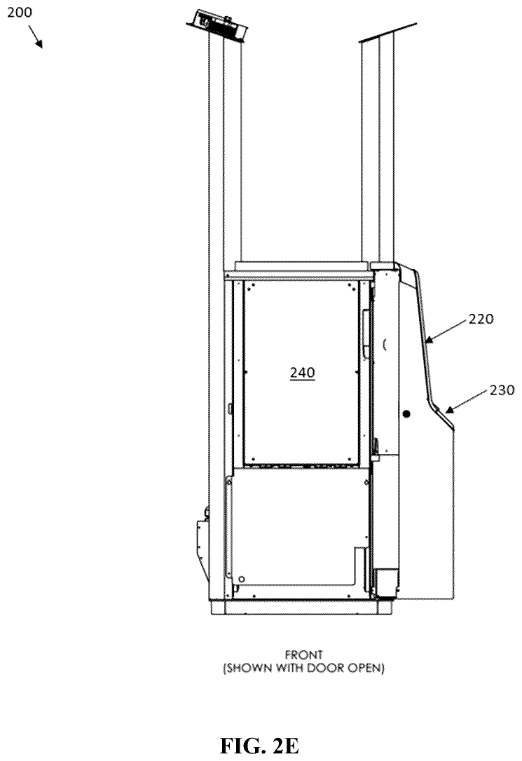

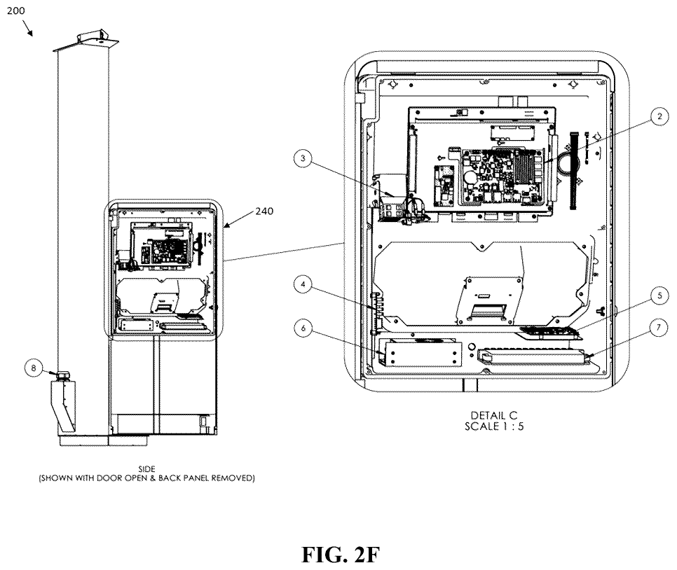

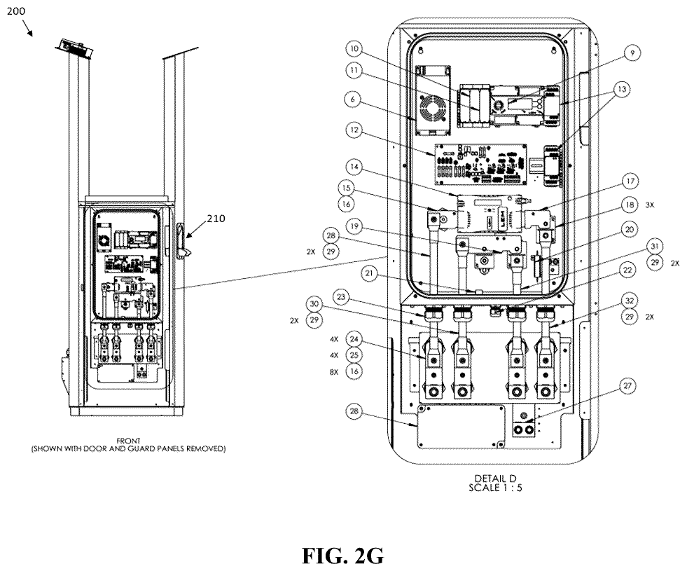

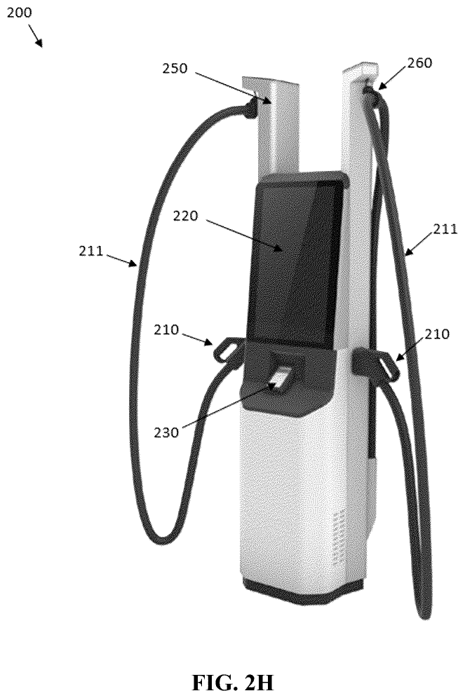

However, in other embodiments, the EV charging station 150 can be a novel EV charger or EVSE, such as the EV charging station 200 shown in FIGS. 2A-2G. In detail, FIG. 2A illustrates a perspective view of one embodiment of the EV charging station 200; FIGS. 2B and 2C illustrate front views of one embodiment of the EV charging station 200; FIG. 2D illustrates a side view of one embodiment of the EV charging station 200; FIG. 2E illustrates a front view of one embodiment of the EV charging station 200 with a door 240 opened; FIG. 2F illustrates a side view of one embodiment of the EV charging station 200 with the door 240 opened and a back panel removed; FIG. 2G illustrates a front view of one embodiment of the EV charging station 200 with the door 240 and guard panels removed; and FIG. 2A illustrates another perspective view of one embodiment of the EV charging station 200.

As shown in FIGS. 2A-2H, the EV charging station 200 can generally include a housing to encompass all necessary circuitry and hardware to provide electric vehicle charging, as well as software and communication modules needed for communicating with the fueling platform 110 and other remote entities, so the EV charging station 200 can receive control commands from the fueling platform 110 and execute various charging operations accordingly. According to some implementations, the EV charging station 200 can house the fueling platform 110 in its entirety, such that the EV charging station 200 provides an all-in-one EV charging platform which integrates the fueling platform 110 (see, e.g., FIG. 2H). In other implementations, the EV charging station 200 can house only select portions of the fueling platform 110 (e.g., EV charging station controller 140), or the fueling platform 110 can be entirely physically separate from the EV charger.

The EV charging station 200 can connect to a power cabinet 152, as described in further detail below, and receive power from the power cabinet 152, enabling the EV charging station 200 to supply electricity to an EV. The EV charging station 200 can operate using various charging standards such as Combined Charging System (CCS), using Combo 1 (CCS1) or Combo 2 (CCS2), North American Charging Standard (NACS), i.e., SAE J3400, etc. The EV charging station 200, in some embodiments, can incorporate one or more connectors 210 coupled to one or more charging cables 211, respectively, to provide power at up to 280 KW per connector, although the specified power outputs of the EV charging station 200 can be modified depending on the implementation. The EV charging station 200 can also support dual cable power sharing (e.g., 140 KW for each connector 210) to provide simultaneous charging, in certain implementations. Furthermore, the EV charging station 200 can be configured to provide a continuous DC amperage of 250 A, or in certain cases, up to 500 A. The charging cables 211 coupled to each connector 210 can be air-cooled, or liquid-cooled in the case of higher power outputs such as 500 A. The EV charging station 200 can also be configured to communicate with EVs, other EVSEs, or any other electric charging infrastructure via ISO 15118, a standard for secure communication within EV charging networks.

As shown in FIG. 2H, for example, the EV charging station 200 can also include charging cable suspension members 260 that accommodate the charging cables 211. The charging cable suspension members 260 can be disposed near a top portion of the upper columns or arms of the EV charging station 200 and can include a hollow or circular portion through which the charging cables 211 can pass, thus preventing the charging cables 211 from being tangled or resting on the ground where they can be susceptible to damage. Further, the charging cable suspension members 260 can allow a customer to easily pull the charging cables to an opposite side of the EV charging station 200 as needed without tangling. To this end, the charging cable suspension members 260 can include a retractable cord that can be pulled downwardly to allow for additional extension of the charging cables 211 and then retract back into the housing of charging station 200 when the charging cables 211 is no longer in use.

In some embodiments, the EV charging station 200 can include a multimedia display 220 (e.g., display module 112) configured to display multimedia content (e.g., images and/or videos). The multimedia content can be stored locally at the EV charger or can be streamed from a remote location via a wireless communication link. In some implementations, the multimedia content can be personalized to the customer using the EV charging station 200, e.g., based on a customer profile managed and/or stored by the fueling platform 110. The multimedia display 220 can further include speakers (not shown) for outputting audio in conjunction with the multimedia content.

Furthermore, in some embodiments, the EV charging station 200 can include a point-of-sale (POS) terminal 230 (e.g., POS terminal 160) configured to accept various types of payment, such as credit or debit card payment, mobile payment, and/or other forms of contactless payment (e.g., RFID, NFC, etc.), allowing a customer to pay using traditional payment methods for charging an EV. The EV charging station 200, in some embodiments, can further allow a customer to pay using stored payment methods, e.g., based on a customer profile managed and/or stored by the fueling platform 110, whereby the customer profile is linked with payment data (such as a bank account or other online payment account), by swiping or tapping a card associated with the customer, or by inputting unique customer identifying information associated with the customer profile, at the POS terminal 230. For example, the POS terminal 230 may include an RFID reader for accepting payment via a loyalty card that is linked to a customer's customer profile (in addition to, or instead of, accepting any of the other payment methods mentioned above). The POS terminal 230 may be any suitable commercial POS terminal known in the art (e.g., POS terminal 160) configured to accept any of the aforementioned methods of payment and may be wirelessly connected to a remote POS server (e.g., payment processing server 161) configured to process the payment information using known payment processing techniques.

Furthermore, in certain embodiments, the EV charging station 200 can include light-emitting diode (LED) indicator lights 250 configured to emit light from a location on the EV charging station 200. For example, the LED indicator lights 250 can be vertically disposed along the upper columns or “arms” of the charging station 200 in the shape of a vertical strip, as shown in FIG. 2H. Alternatively, the LED indicator lights 250 can be disposed at any other location of the charging station 200. In some embodiments, the LED indicator lights 250 can be visible from all sides of the EV charging station 200 to assist drivers in locating the charging station 200. The LED indicator lights 250 can include bright LEDs designed for visibility in daylight and also dimmable at night.

Further, in some embodiments, the LED indicator lights 250 can be configured to emit light having a particular color, brightness, and/or other attribute according to a status of the EV charging station 200. To this end, the LED indicator lights 250 can be operatively controlled by a processor (e.g., processor 311) of the charging station 200 such that the lights can change dynamically during a charging operation. This can be executed in any number of ways. As an example, a green light can be emitted to indicate that the EV charging station 200 is available; a yellow/orange light can be emitted to indicate that the EV charging station 200 is faulty/out of order; and a blue light can be emitted to indicate that the EV charging station 200 is connected to a vehicle, in use, or otherwise occupied. Further, in some embodiments, a steady blue light can be emitted to indicate that the EV charging station 200 is occupied, while a blinking/animated blue light can be emitted to indicate a variety of real-time status updates including, for example, a percentage of charge or a rate of charge. In one example, the current percentage of charge can be indicated by illuminating only a specific height of the LED indicator lights 250 (e.g., a 30% charge can be indicated by illuminating 30% of the height of the LED indicator lights 250), and the current rate of charge can be indicated by having the lighted section of the LED indicator lights 250 continuously “scroll” from the bottom (e.g., faster scrolling would indicate a faster charge rate). It should be understood that these examples are merely illustrative and can be modified in any suitable fashion in accordance with the present claims.

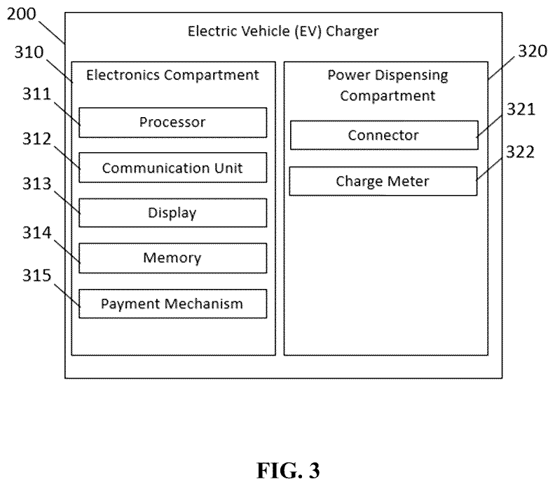

The EV charging station 200 can have a variety of configurations. For example, FIG. 3 illustrates a schematic view of one embodiment of the EV charging station 200. As shown, the EV charging station 200 can include an electronics compartment 310 and a power dispensing compartment 320. The electronics compartment 310 can contain therein electronics for facilitating payment for electricity dispensed (or other goods and services) to an EV and for facilitating the dispensing of the electricity. The electronics can include, for example, a processor 311 configured to control various electronic components of the EV charging station 200 and dispensing of electricity from the power dispensing compartment 320, a communication unit 312 configured to electronically communicate via a wired and/or wireless communication link, a display 313 (e.g., multimedia display 220) configured to display information (e.g., media content, payment information, etc.), a memory 314 configured to store data therein that is readable by the processor 311, and a payment mechanism 315 (e.g., POS terminal 230) configured to facilitate payment for electricity dispensed (and/or other goods or services).

The display 313 can configured to show information to a user of the EV charging station 200. The display 313 can have any of a variety of configurations, such as a cathode ray tube (CRT) screen, a liquid crystal display (LCD) screen, a light emitting diode (LED) screen, a touchscreen, and the like. For example, the display 313 can include a single display. Alternatively, the display 313 can include multiple displays. For example, a first display 313 can be on a front side of the EV charging station 200 and a second display 313 can be on a back side of the EV charging station 200. As another example, the display 313 can include two displays mounted next to each other to increase an overall display size. As yet another example, the display 313 can include first and second displays mounted next to each other on a front side of the EV charging station 200 and can include third and fourth mounted next to each other on a back side of the EV charging station 200.

The EV charging station 200 can, in some implementations, include at least one media output device in addition to the display 313. For example, the at least one media output device can include a speaker configured to output audio therefrom.

The communication unit 312 can have a variety of configurations. For example, the EV charging station 200 can include a communication unit 312 configured to communicate wirelessly with a remote system (e.g., a remote cloud server, a third-party payment authorization system, etc.) according to any of a variety of communication protocols, e.g., TCP/IP, etc. In some implementations, the communication unit 312 can be configured to communicate over a wired connection in addition to or instead of over a wireless connection. A wired connection can be used, for example, for a local communication link between the EV charging station 200 and a local computing system external to the EV charging station 200 (e.g., a forecourt controller, an in-store POS device, etc.). A wired connection may provide more security and/or stability than a wireless connection and/or may allow a legacy EV charger configured to communicate only via one or more wired connections to implement dynamic management of display content as described herein. Wired communication can occur via any of a variety of wired communication protocols, e.g., TCP/IP, etc., as will be appreciated by a person skilled in the art. Some EV chargers are manufactured with two-wire connectivity, and the wired communication can accordingly be via two wires, such as via a controller area network bus (CANBus) two wire connection, an RS485 two wire connection, a current loop connection, or other type of two wire connection. Some EV chargers are additionally or alternatively manufactured with cable connectivity and can accordingly be configured to provide wired communication via cable connection, such as an Ethernet cable or other network cable. Older EV chargers typically have two-wire connectivity capabilities while newer EV chargers typically have Ethernet connectivity capabilities instead.

In some implementations, the communication unit 312 can be configured to facilitate wireless communication over a wireless communication link. For example, the communication unit 312 can include a transceiver configured to communicate via any of a variety of wireless techniques, such as a Bluetooth protocol, a Wi-Fi protocol, near field communication (NFC), an ultra-wideband (UWB) protocol, a radio frequency identification (RFID) protocol, etc. Any of a variety of types of wireless connectivity hardware can be used for wireless connectivity, as will be appreciated by a person skilled in the art. The types of wireless connectivity that the communication unit 312 includes can be chosen by an owner of the EV charging station 200 according to the owner's current fueling site setup and/or future fueling site plans, and the communication unit 312 may be manufactured and/or updated accordingly.

The power dispensing compartment 320 of the EV charging station 200 can, as in this illustrated implementation, have therein a connector 321 (e.g., connector 210) configured to supply electrical charge from a power cabinet (e.g., power cabinet 400) or other power source, such as the power grid, and has therein a charge meter 322 configured to monitor the amount and/or rate of electricity dispensed to an EV. The power dispensing compartment 320 can also include other elements to facilitate electricity dispensing, such as wires, a cable cooling system, etc., as will be appreciated by a person skilled in the art. The power dispensing compartment 320 can be isolated from the electronics compartment 310 within the EV charging station 200 to facilitate safety, security, and/or maintenance, as will be appreciated by a person skilled in the art. Electricity is configured to flow through a charge cable via the connector 321 to a battery of the EV. The EV charging station 200 can include any number of connectors 321 and associated charge cables.

In some implementations, via ISO 15118, an EV can not only receive electrical charge but also return stored energy to the grid. For example, the EV charging station 200 (via the EV charging station controller 140) can communicate with an EV in real-time to establish a charging and discharging schedule through ISO 15118. Energy flow parameters can be securely exchanged between an EV and the EV charging station 200. In some instances, the controller of EV charging station 200 can adjust the charging and discharging rates based on factors such as grid demand, electricity pricing, battery state-of-charge (SoC), and the like. For example, the EV charging station can deliver electrical charge to the EV during one or more charging periods of the charging and discharging schedule, while the EV can return electrical charge to the grid during one or more discharging periods of the charging and discharging schedule. In some cases, a grid operator can request energy from connected EVs during peak demand periods and replenish EV batteries during off-peak hours.

A person skilled in the art will appreciate that the EV charging station 200 can have various other configurations. Various exemplary implementations of EV chargers and fuel dispensers are described further in, for example, U.S. Pat. No. 10,214,411 entitled “Fuel Dispenser Communication” issued Feb. 26, 2019, U.S. Pat. No. 10,269,082 entitled “Intelligent Fuel Dispensers” issued Apr. 23, 2019, U.S. Pat. No. 10,577,237 entitled “Methods And Devices For Fuel Dispenser Electronic Communication” issued Mar. 3, 2020, U.S. Pat. No. 10,726,508 entitled “Intelligent Fuel Dispensers” issued Jul. 28, 2020, U.S. Pat. No. 11,276,051 entitled “Systems And Methods For Convenient And Secure Mobile Transactions” issued Mar. 15, 2022, U.S. Pat. No. 11,429,945 entitled “Outdoor Payment Terminals” issued Aug. 30, 2022, and U.S. Pat. App. Pub. No. 2023/0196360 entitled “Conducting Fuel Dispensing Transactions” published Jun. 22, 2023, which are hereby incorporated by reference in their entireties.

It is to be understood that the specifications and features of the EV charging station 200 set forth in the present disclosure and figures are intended merely for illustration purposes only and should not be construed as limiting the scope of the present claims. Therefore, aspects of the EV charging station 200 can be modified as needed, according to the needs of the local retailers, customers, etc., without departing from the spirit of the present claims.

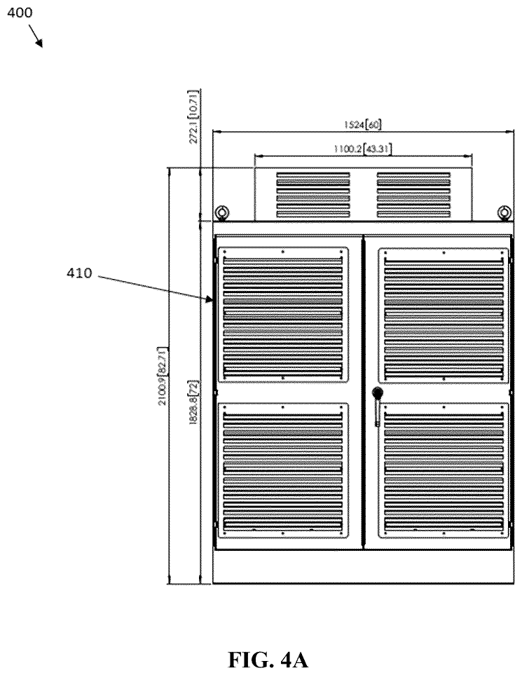

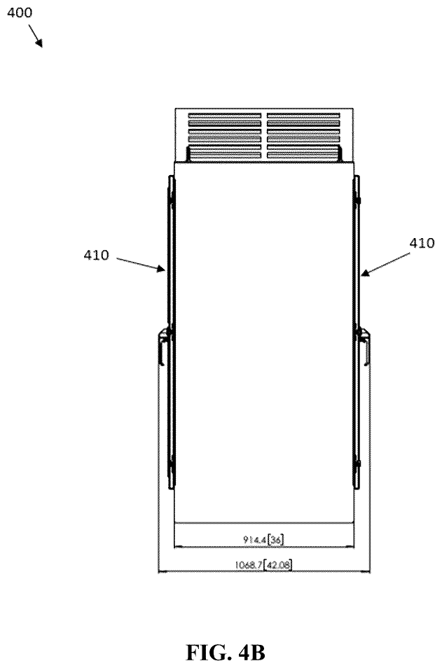

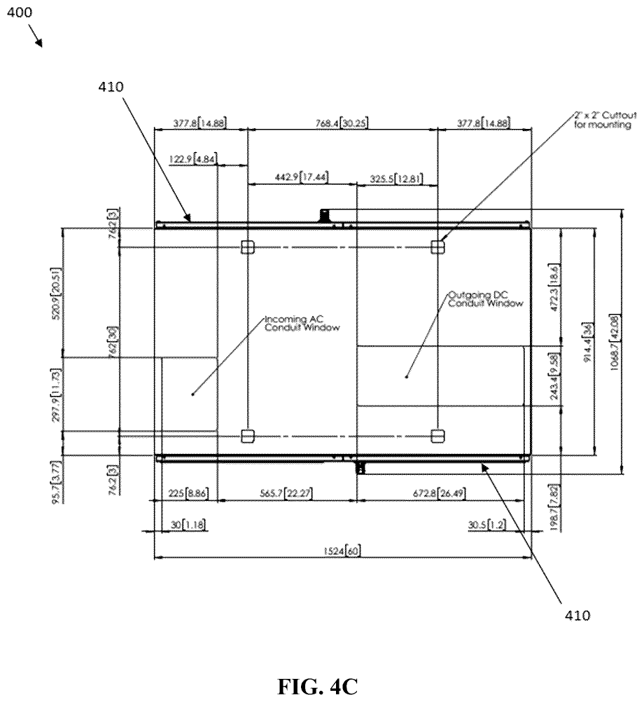

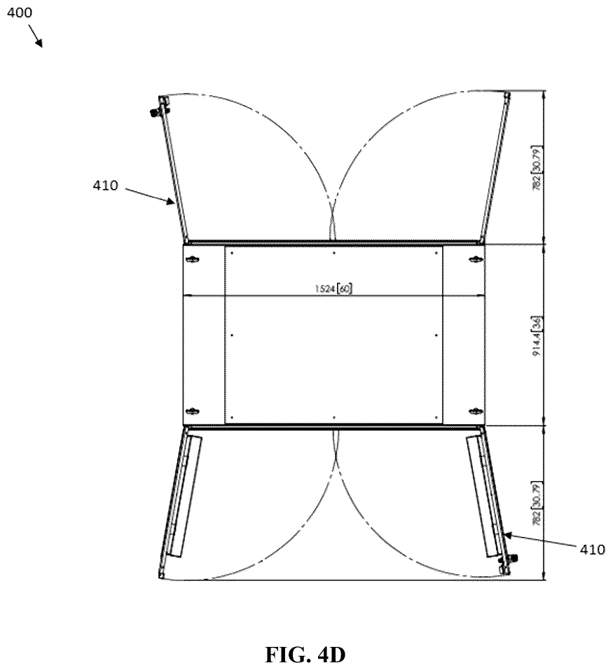

As mentioned above, the EV charging station 200 can connect to the power cabinet 152 so as to receive power therefrom, enabling the EV charging station 200 to supply electricity to an EV. The power cabinet 152 can be a power cabinet well-known in the art for supplying power to an EV charger, or in other embodiments, the power cabinet 152 can be a novel power cabinet 400 as illustrated in FIGS. 4A-4D. In detail, FIG. 4A illustrates a front view of one embodiment of the power cabinet 400; FIG. 4B illustrates a side view of one embodiment of the power cabinet 400; FIG. 4C illustrates a top view of one embodiment of the power cabinet 400; and FIG. 4D illustrates a top view of one embodiment of the power cabinet 400 with doors 410 opened.

As shown in FIGS. 4A-4D, the power cabinet 400 is operable to be connected to the EV charging station 200 and generally configured to dispense power to the EV charging station 200 for charging an EV (e.g., up to 500 A). In some embodiments, the power cabinet 400 can be connected to multiple EV chargers and simultaneously dispense power to each charger. The power cabinet 400 can be connected to a power source, such as the power grid, to enable the supply of electricity to the EV charging station 200, as would be appreciated by a person of ordinary skill in the art. It is to be understood, however, that these aspects of the power cabinet 400 can be modified and should not be treated as limiting the scope of the present claims.

Referring again to FIG. 1, in some implementations, the EV charging station controller 140 can control the operation of the EV charging station 150 via an EV charging station API platform 151 (such as an API platform provided by EcoG®). Typically, the EV charging station API platform 151 can be managed by a third-party entity that also manufactures the EV charging station 150. The EV charging station API platform 151, in some implementations, can receive control commands from the EV charging station controller 140 using a specified EV charger API (such as EcoG® OPEN API) and can forward corresponding commands to the EV charging station 150 such that the EV charging station controller 140 can control the operation of the EV charging station 150. In turn, the EV charging station API platform 151 can obtain operation information indicating an operating status of the EV charging station 150 and forward corresponding signals to the EV charging station controller 140 so it can monitor the performance status of the EV charging station 150. Additionally, in certain embodiments, the EV charging station API platform 151 can be in communication with a remote cloud-based charge point management system (CPMS) 153 configured to provide real-time performance monitoring of a fleet of EV chargers including the EV charging station 150. Communications between the CPMS 153 and the EV charging station API platform 151 can be exchanged using a standard protocol specific for EV charging stations such as Open Charge Point Protocol (OCPP) which defines how charge stations and central management systems transmit commands like start and stop power, as well as diagnostic data such as how much power is being consumed or if there are any errors. Alternatively or in addition, the existing OCPP implementations can have ISO 15118 integrated therein to allow bi-directional data exchange between the EV charging station controller 140 and one or more backend systems, such as CPMS 153 or a payment processing server 161.

Additionally, the fueling platform 110 can be in communication with a POS terminal 160 configured to accept payments such as credit or debit card payment, mobile payment, and/or other forms of contactless payment (e.g., RFID, NFC, etc.), allowing a customer to pay using traditional payment methods for charging an EV, as described in further detail below. In some embodiments, the POS terminal 160 can be provided and managed by a third-party payment processing entity (such as PAX®). The POS terminal 160 can be any suitable POS terminal such as, for example, a PAX® IM30 Unattended Terminal, although it is to be understood the present disclosure is not limited thereto. The POS terminal 160 can include a display screen, communication modules, processing circuitry, memory, input devices such as buttons, a touchscreen, etc., a chip reader, a card (e.g., magnetic stripe) swiping slot, and any other components necessary for implementing a POS terminal.

The POS terminal 160 can be remotely managed by the payment processing server 161 in wireless communication with the POS terminal 160. The payment processing server 161 can be configured to receive payment information upon initiation of a payment transaction and to send payment completion information to complete the payment transaction, as would be appreciated by a person of ordinary skill in the art. Furthermore, the POS terminal 160 can be in remote communication with a financial services provider 162 configured to provide financial information (e.g., bank account information, fund information, etc.) necessary for authorizing a payment transaction, as would be appreciated by a person of ordinary skill in the art.

Payment transaction information (e.g., credit card numbers, bank account numbers, payment amounts, etc.) can be exchanged between the POS terminal 160 and the fueling platform 110 via a POS terminal software plugin 163 (or “POS terminal plugin”) configured to communicate with the POS terminal 160. The POS terminal software plugin 163 can be specifically programmed to communicate using a protocol that is utilized by the POS terminal 160. Upon receiving payment transaction information from the POS terminal 160, the POS terminal software plugin 163 can transmit said information to the EV charging station controller 140 via the message bus 111, whereupon the EV charging station controller 140 can effectively complete the EV charging transaction based on the customer's payment at the POS terminal 160, as discussed in greater detail below.

Furthermore, the fueling platform 110 include a PCF module 164 configured to communicate with the POS terminal 160 and to receive “PCF payment information” from the POS terminal 160. For the purposes of the present disclosure, “PCF” is referred to herein as a customer payment program in which a customer can submit payment for a fueling or charging transaction using payment information that is locally stored (e.g., in the fueling platform database 122). In some implementations, the locally stored payment information may be associated with a customer profile, as described in detail above. In additional implementations, the customer can possess a “PCF card” that is linked to the customer's payment information, such that the customer may initiate a charging transaction by swiping his or her PCF card at the POS terminal 160, causing the PCF module 164 to retrieve the corresponding payment information locally stored at the database 122. Advantageously, this payment method can be used as an alternative to a debit or credit card, eliminating the need to communicate with the financial services provider 162 to authorize and complete an EV charging transaction.

As noted above, the fueling platform 110 can be configured to provide the payment management system 100 for an EV charger, such as the EV charging station 150. In this regard, two exemplary processes for implementing the payment management system 100 are described hereinbelow. In general, the processes as described herein can be implemented by various components of the payment management system 100 described above, including the EV charging station 150, the EV charging station API platform 151, the fueling platform 110 including the EV charging station controller 140, the display module 112, and the POS terminal software plugin 163, the POS terminal 160, and the financial services provider 162. It is to be understood that other components can also be involved in the payment management system 100, and other actions not explicitly described below can be performed as part of the payment management system 100. Therefore, the following processes should not be construed as limiting the present disclosure beyond the scope of the claims defined herein.

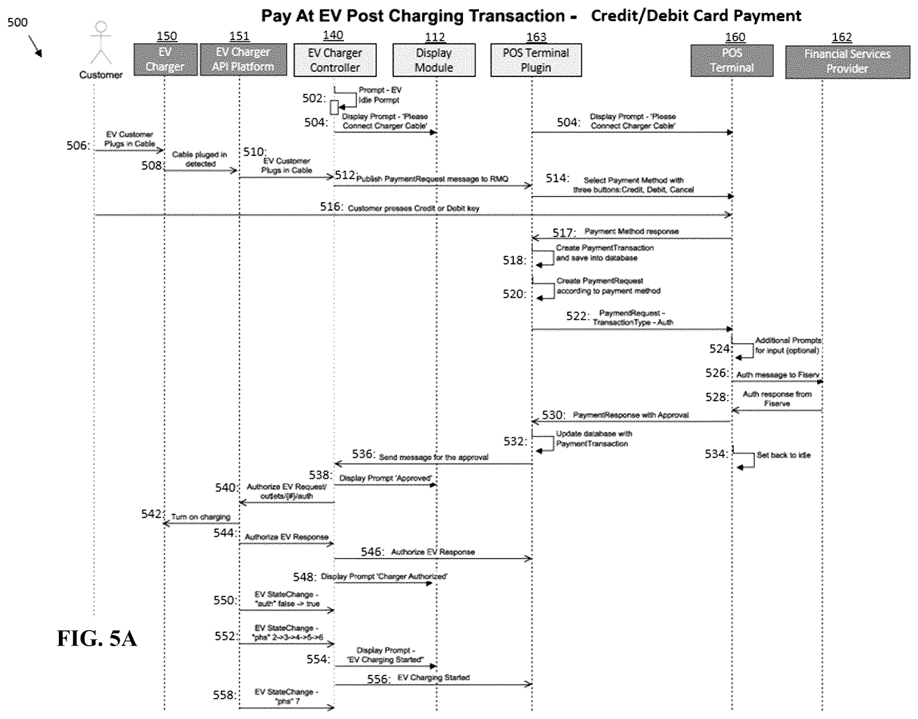

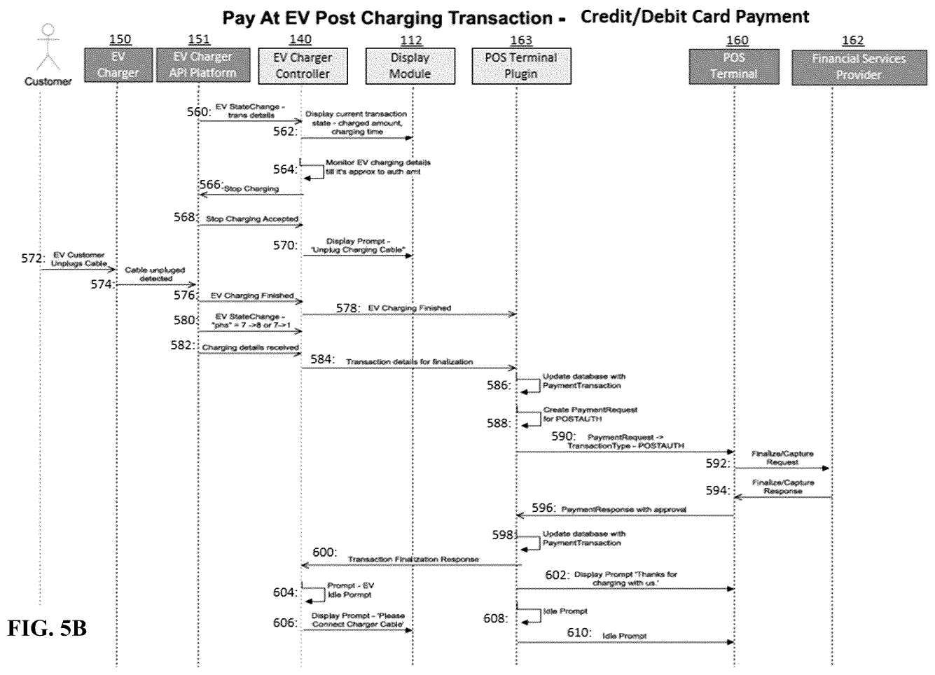

Firstly, FIGS. 5A and 5B illustrate a first embodiment of a process 500 for implementing the payment management system 100 for the EV charging station 150 using a credit or debit card. The process 500 is described with respect to the payment management system 100 of FIG. 1 for ease of explanation but can be performed with other similarly configured systems. The process 500 starts at step 502, where the EV charging station controller 140 initially operates in an “idle” state. At step 504, the EV charging station controller 140 can cause the display module 112 to display a prompt: “Please Connect Charger Cable.” Similarly, the POS terminal plugin 163 can cause the POS terminal 160 to display the prompt: “Please Connect Charger Cable.”

At step 506, the EV customer can plug the charging cable of the EV charging station 150 into an EV. At step 508, the EV charging station 150 can detect that the charging cable has been plugged into an EV. At step 510, the EV charging station API platform 151 can notify the EV charging station controller 140 that the customer has plugged in the charging cable of the EV charging station 150. At step 512, the EV charging station controller 140 can instruct the POS terminal plugin 163 to send a command instructing the POS terminal 160 to request payment from the customer.

At step 514, the POS terminal 160 can display a request for the customer to select a payment method (e.g., using buttons or the touchscreen): Credit, Debit, or Cancel. At step 516, the customer can select a payment method by selecting either Credit or Debit at the POS terminal 160. In response, at step 517, the POS terminal 160 can send an indication of the selected payment method to the POS terminal plugin 163.

At step 518, the POS terminal plugin 163 can create a payment transaction record and save the same in a database (e.g., fueling platform database 122), and at step 520, the POS terminal plugin 163 can create a payment request record according to the customer's selected payment method. Then, at step 522, the POS terminal plugin 163 can send authorization for the selected payment method to the POS terminal 160. At step 524, the POS terminal 160 can optionally display any additional prompts as necessary, and at step 526, the POS terminal 160 can send an authorization message to the financial services provider 162.

In response, at step 528, the financial services provider 162 can send an authorization response to the POS terminal 160, causing the POS terminal 160 to send a payment response approval to the POS terminal plugin 163 at step 530. The POS terminal plugin 163 can then update the fuel platform database 122 with the approved payment transaction information, at step 532, indicating that the transaction has been approved, at which point the POS terminal 160 can reset to an idle state at step 534.

At step 536, the POS terminal plugin 163 can send an approval message to the EV charging station controller 140, indicating that the EV charging has been approved and may proceed. At step 538, the EV charging station controller 140 can cause the display module 112 to display a prompt: “Approved.” Then, at step 540, the EV charger controller can send a command to the EV charging station API platform 151 to authorize the customer's EV charging request, causing the EV charging station API platform 151 to send an instruction to the EV charging station 150 to activate charging at step 542. The EV charging station API platform 151 can also send a response to the EV charging station controller 140 indicating that the EV charging is being activated at step 544, and at step 546, the EV charging station controller 140 can send a corresponding response to the POS terminal plugin 163.

At step 548, the EV charging station controller 140 can cause the display module 112 to display a prompt: “Charger Authorized.” Then, at step 550, the EV charging station API platform 151 can send a message to the EV charging station controller 140 switching an EVStateChange “Auth” variable from ‘false’ to ‘true’, indicating that charging has been authorized. Similarly, at step 552, the EV charging station API platform 151 can send another message to the EV charging station controller 140 changing an EVStateChange “phs” variable from 2 to 3 to 4 to 5 to 6, indicating an increasing charging rate of the EV charging station 150 as the EV charging station 150 supplies electricity to the EV. At step 554, the EV charger controller can cause the display module 112 to display a prompt: “EV Charging Started.” At step 556, the EV charging station controller 140 can send a notification to the POS terminal plugin 163 that EV charging has started. Meanwhile, at step 558, the EV charging station API platform 151 can send another message to the EV charging station controller 140 changing the EVStateChange “phs” variable from 6 to 7, indicating a still increasing charging rate of the EV charging station 150.

At step 560, the EV charging station API platform 151 can send real-time updates to the EV charging station controller 140 so the EV charging station controller 140 can monitor the current charging transaction of the EV charging station 150. At step 562, the EV charging station controller 140 can cause the display module 112 to display the current status of the ongoing charging transaction, such as the charged amount, the charging time, etc., and at step 564, the EV charging station controller 140 can continue to monitor the EV charging transaction until the amount of charge reached or electricity delivered reaches completion (e.g., when the EV is fully charged or when an amount of charge indicated by the customer is reached).

Upon charging completion, at step 566, the EV charging station controller 140 can send an instruction to the EV charging station API platform 151 to stop charging. At step 568, the EV charging station API platform 151 can send a response to the EV charging station controller 140 accepting the instruction to stop charging. Then, at step 570 the EV charging station controller 140 can cause the display module 112 to display a prompt: “Unplug Charging Cable.”

At step 572, the customer can unplug the charging cable from the EV, at which point the EV charging station 150 can detect that the charging cable has been disconnected at step 574. At step 576, the EV charging station API platform 151 can send a notification to the EV charging station controller 140 that the EV charging has finished, causing the EV charging station controller 140 to send a corresponding notification to the POS terminal plugin 163 at step 578. At step 580, the EV charging station API platform 151 can send another message to the EV charging station controller 140 changing the EVStateChange “phs” variable from 7 to 8, or 7 to 1, indicating that the EV charging station 150 is no longer supplying electricity to the EV. At step 582, the EV charging station API platform 151 can send any additional details regarding completion of the EV charging transaction to the EV charging station controller 140, which can be forwarded to the POS terminal plugin 163 to finalize the charging transaction at step 584.

At step 586, the POS terminal plugin 163 can update the fuel platform database 122 with the finalized payment transaction information, and at step 588, the POS terminal plugin 163 can create a payment request for post-authorization which, in turn, can be sent to the POS terminal 160 at step 590. At step 592, the POS terminal 160 can send a request to the financial services provider 162 for finalizing/capturing the EV charging transaction, causing the financial services provider 162 to send a finalization/capture response to the POS terminal 160 at step 594. At step 596, the POS terminal 160 can send an approved payment response to the POS terminal plugin 163, causing the POS terminal plugin 163 to update the fuel platform database 122 with the transaction approval received from the financial services provider 162 at step 598.

At step 600, the POS terminal plugin 163 can send a transaction finalization response to the EV charging station controller 140, indicating that the EV charging transaction is finalized. At step 602, the POS terminal plugin can cause the POS terminal 160 to display a prompt: “Thanks for charging with us.” At step 604, the EV charging station controller 140 can re-enter the “idle” state, and can cause the display module 112 to display the prompt: “Please Connect Charger Cable,” at step 606. Finally, at step 608, the POS terminal plugin 163 can enter an “idle” state, and at step 610, the POS terminal plugin 163 can cause the POS terminal 160 to similarly enter an “idle” state.

The process 500 then ends at step 610. It should be noted that while certain steps within the process 500 may be optional as described above, the steps shown in FIGS. 5A and 5B are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

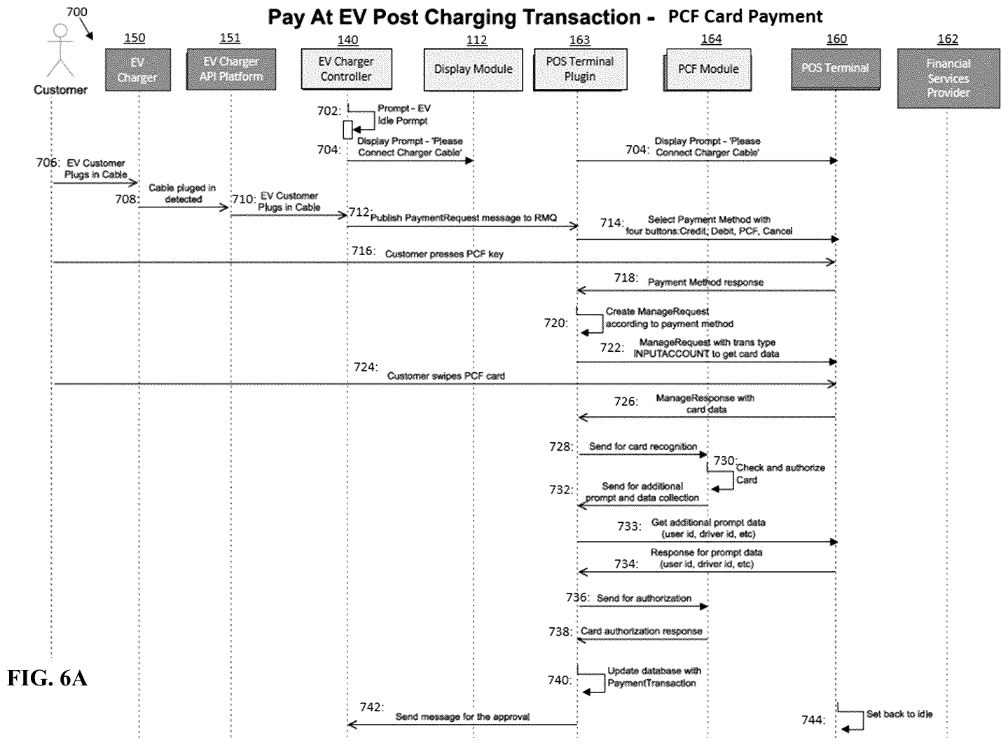

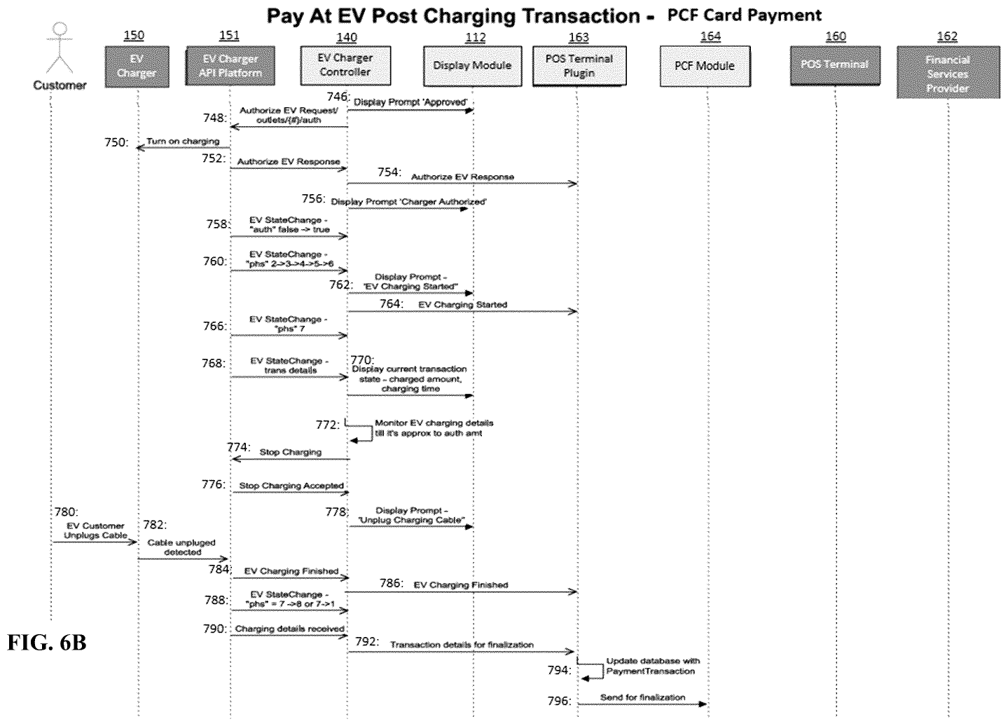

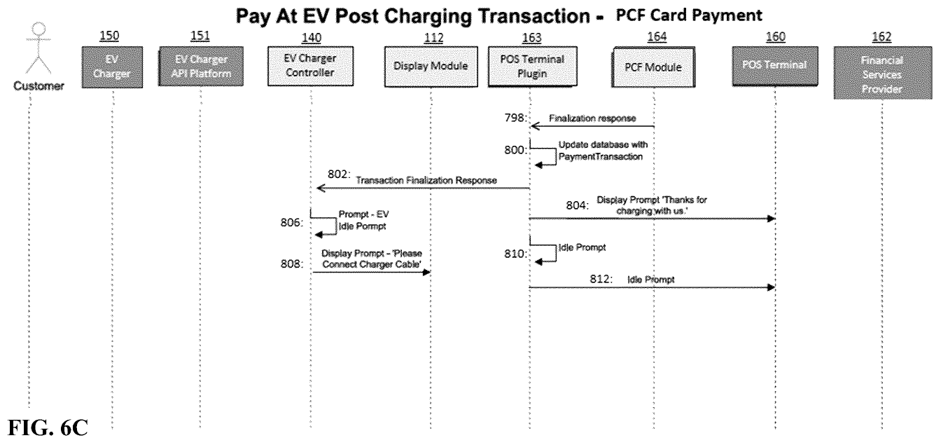

Additionally, FIGS. 6A-6C illustrate a second embodiment of another process 700 for implementing the payment management system 100 for the EV charging station 150 using locally stored payment information. In general, much of the process 700 can mirror the process 500, except the customer uses a “PCF card,” as described above, for payment of the EV charging transaction. Use of the PCF card, which relies upon locally stored information for payment, can eliminate the need for the external financial services provider 162, as the customer's payment for EV charging can be validated and authorized locally by the fuel platform 110.

The process 700 starts at step 702, where the EV charging station controller 140 initially operates in an “idle” state. At step 704, the EV charging station controller 140 can cause the display module 112 to display a prompt: “Please Connect Charger Cable.” Similarly, the POS terminal plugin 163 can cause the POS terminal 160 to display the prompt: “Please Connect Charger Cable.”

At step 706, the EV customer can plug the charging cable of the EV charging station 150 into an EV. At step 708, the EV charging station 150 can detect that the charging cable has been plugged into an EV. At step 710, the EV charging station API platform 151 can notify the EV charging station controller 140 that the customer has plugged in the charging cable of the EV charging station 150. At step 712, the EV charging station controller 140 can instruct the POS terminal plugin 163 to send a command instructing the POS terminal 160 to request payment from the customer.

At step 714, the POS terminal 160 can display a request for the customer to select a payment method (e.g., using buttons or the touchscreen): Credit, Debit, PCF, or Cancel. At step 716, the customer can select a payment method by selecting “PCF” at the POS terminal 160. In response, at step 718, the POS terminal 160 can send an indication of the selected payment method to the POS terminal plugin 163.

At step 720, the POS terminal plugin 163 can create a payment request record according to the customer's selected payment method (PCF). Then, at step 722, the POS terminal plugin 163 can send a request for the customer's PCF card data to the POS terminal 160. At step 724, the customer can swipe his or her PCF card at the POS terminal 160, and the POS terminal 160 can then provide the PCF card data to the POS terminal plugin 163 at step 726.

At step 728, the POS terminal plugin 163 can send a message to the PCF module 164 requesting recognition of the PCF card, to authenticate the card. In response, at step 730, the PCT module 164 can access PCF records locally stored in the fueling platform database 122 to authorize the customer's PCF card. In some embodiments, the process can advance to step 732, where the PCF module 164 sends a request for additional identifying information to the POS terminal plugin 163, causing the POS terminal plugin 163 to send a command to the POS terminal 160 to display a prompt requesting additional identifying information from the customer (e.g., a username or user ID, a drivers license, etc.). The POS terminal 160 can then receive the identifying information from the customer and send such information in a response to the POS terminal plugin at step 734.

At step 736, the POS terminal plugin 163 can send a transaction authorization to the PCF module 164, which in turn can send an authorization response back to the POS terminal plugin 163 at step 738. At step 740, the POS terminal plugin 163 can update the database 122 with payment transaction information, and furthermore, the POS terminal plugin 163 can send a message indicating approval of the EV charging transaction to the EV charging station controller 140. Meanwhile, at step 744, the POS terminal 160 can reset to an “idle” state.

At step 746, the EV charging station controller 140 can cause the display module 112 to display a prompt: “Approved.” Then, at step 748, the EV charging station controller 140 can send a command to the EV charging station API platform 151 to authorize the customer's EV charging request, causing the EV charging station API platform 151 to send an instruction to the EV charging station 150 to activate charging at step 750. The EV charging station API platform 151 can also send a response to the EV charging station controller 140 indicating that the EV charging is being activated at step 752, and at step 754, the EV charging station controller 140 can send a corresponding response to the POS terminal plugin 163.

At step 756, the EV charging station controller 140 can cause the display module 112 to display a prompt: “Charger Authorized.” Then, at step 758, the EV charging station API platform 151 can send a message to the EV charging station controller 140 switching an EVStateChange “Auth” variable from ‘false’ to ‘true’, indicating that charging has been authorized. Similarly, at step 760, the EV charging station API platform 151 can send another message to the EV charging station controller 140 changing an EVStateChange “phs” variable from 2 to 3 to 4 to 5 to 6, indicating an increasing charging rate of the EV charging station 150 as the EV charging station 150 supplies electricity to the EV. At step 762, the EV charger controller can cause the display module 112 to display a prompt: “EV Charging Started.” At step 764, the EV charging station controller 140 can send a notification to the POS terminal plugin 163 that EV charging has started. Meanwhile, at step 766, the EV charging station API platform 151 can send another message to the EV charging station controller 140 changing the EVStateChange “phs” variable from 6 to 7, indicating a still increasing charging rate of the EV charging station 150.

At step 768, the EV charging station API platform 151 can send real-time updates to the EV charging station controller 140 so the EV charging station controller 140 can monitor the current charging transaction of the EV charging station 150. At step 770, the EV charging station controller 140 can cause the display module 112 to display the current status of the ongoing charging transaction, such as the charged amount, the charging time, etc., and at step 772, the EV charging station controller 140 can continue to monitor the EV charging transaction until the amount of charge reached or electricity delivered reaches completion (e.g., when the EV is fully charged or when an amount of charge indicated by the customer is reached).

Upon charging completion, at step 774, the EV charging station controller 140 can send an instruction to the EV charging station API platform 151 to stop charging. At step 776, the EV charging station API platform 151 can send a response to the EV charging station controller 140 accepting the instruction to stop charging. Then, at step 778 the EV charging station controller 140 can cause the display module 112 to display a prompt: “Unplug Charging Cable.”

At step 780, the customer can unplug the charging cable from the EV, at which point the EV charging station 150 can detect that the charging cable has been disconnected at step 782. At step 784, the EV charging station API platform 151 can send a notification to the EV charging station controller 140 that the EV charging has finished, causing the EV charging station controller 140 to send a corresponding notification to the POS terminal plugin 163 at step 786. At step 788, the EV charging station API platform 151 can send another message to the EV charging station controller 140 changing the EVStateChange “phs” variable from 7 to 8, or 7 to 1, indicating that the EV charging station 150 is no longer supplying electricity to the EV. At step 790, the EV charging station API platform 151 can send any additional details regarding completion of the EV charging transaction to the EV charging station controller 140, which can be forwarded to the POS terminal plugin 163 to finalize the charging transaction at step 792.

At step 794, the POS terminal plugin 163 can update the fuel platform database 122 with the finalized payment transaction information, and at step 796, the POS terminal plugin 163 can forward the finalized payment transaction information to the PCF module 164. In response, the PCF module 164 can send a finalization response to the POS terminal plugin 163 at step 798, causing the POS terminal plugin 163 to update the fuel platform database 122 with the transaction approval received from the PCF module 164 at step 800.

At step 802, the POS terminal plugin 163 can send a transaction finalization response to the EV charging station controller 140, indicating that the EV charging transaction is finalized. At step 804, the POS terminal plugin can cause the POS terminal 160 to display a prompt: “Thanks for charging with us.” At step 806, the EV charging station controller 140 can re-enter the “idle” state, and can cause the display module 112 to display the prompt: “Please Connect Charger Cable,” at step 808. Finally, at step 810, the POS terminal plugin 163 can enter an “idle” state, and at step 812, the POS terminal plugin 163 can cause the POS terminal 160 to similarly enter an “idle” state.

The process 700 then ends at step 812. It should be noted that while certain steps within the process 700 may be optional as described above, the steps shown in FIGS. 6A-6C are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow customers to pay for an EV charging transaction using payment methods such as credit and debit cards. Through the payment management system described herein, payment for recharging an EV can become significantly less burdensome by eliminating any limitations against using traditional card-based forms of payment. Furthermore, the disclosed payment management system allows for a customer to pay for an EV charging transaction using locally stored payment information associated with a customer profile, eliminating the need for a remote financial services provider to authorize a payment transaction. Even further, the EV charging station disclosed herein integrates a point-of-sale terminal and fueling platform, amounting to an all-in-one EV charging platform.

One skilled in the art will appreciate further features and advantages of the devices, systems, and methods based on the above-described embodiments. Accordingly, this disclosure is not to be limited by what has been particularly shown and described, except as indicated by the appended claims. All publications and references cited herein are expressly incorporated herein by reference in their entirety for all purposes.

Those skilled in the art will understand that the systems, devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The present disclosure has been described above by way of example only within the context of the overall disclosure provided herein. It will be appreciated that modifications within the spirit and scope of the claims may be made without departing from the overall scope of the present disclosure.

1. A method comprising:
determining, by an electric vehicle (EV) charging station controller, that a charging cable of an EV charging station is plugged into an EV, the EV charging station controller being configured to control an operation of the EV charging station;
initiating, by the EV charging station controller, an EV charging transaction upon receiving an indication of approval of payment for delivery of electrical charge by the EV charging station using a credit card or a debit card via a point-of-sale (POS) terminal, wherein the POS terminal is operably coupled to the EV charging station, and wherein the approval of the payment is provided at least in part by a financial services provider associated with the credit card or the debit card used for payment via the POS terminal;
in response to receiving the indication of the approval of payment, authorizing, by the EV charging station controller, the delivery of electrical charge by the EV charging station, causing the EV charging station to activate delivery electrical charge to the EV; and
causing, by the EV charging station controller, the EV charging station to deactivate the delivery of electrical charge to the EV when the EV charging transaction is complete.

2. The method of claim 1, wherein the EV charging station controller is further configured to control the operation of the EV charging station via an EV charging station application programming interface (API) platform.

3. The method of claim 2, further comprising:
sending, by the EV charging station controller and to the EV charging station API platform, one or more control commands for controlling the operation of the EV charging station via an EV charger API,
wherein the EV charging station API platform provides control commands corresponding to the one or more control commands to the EV charging station, such that the EV charging station controller controls the operation of the EV charging station.

4. The method of claim 1, wherein the initiating of the EV charging transaction comprises:
receiving, at the EV charging station controller, the indication of approval of payment for delivery of electrical charge from the POS terminal.

5. The method of claim 1, wherein the EV charging station controller is configured to communicate with the POS terminal via a POS terminal plugin that is programmed to communicate using a protocol utilized by the POS terminal.

6. The method of claim 5, further comprising:
upon authorizing the delivery of electrical charge, sending, by the EV charging station controller and to the POS terminal plugin, a notification indicating that electrical charge is being delivered to the EV by the EV charging station.

7. The method of claim 5, further comprising:
upon causing the EV charging station to deactivate the delivery of electrical charge, sending, by the EV charging station controller and to the POS terminal plugin, a notification indicating that the delivery of electrical charge to the EV by the EV charging station is finished.

8. The method of claim 5, further comprising:
upon causing the EV charging station to deactivate the delivery of electrical charge, sending, by the EV charging station controller and to the POS terminal plugin, data relating to the EV charging transaction indicative of the electrical charge delivered and payment information.

9. The method of claim 8, wherein the POS terminal plugin is configured to finalize the EV charging transaction with the financial services provider using the payment information.

10. The method of claim 9, further comprising:
receiving, at the EV charging station controller, a notification that the EV charging transaction has been finalized from the POS terminal plugin.

11. The method of claim 1, wherein the EV charging station controller is configured to communicate with the EV charging station via an EV charging station API platform that is programmed to communicate using a protocol utilized by the EV charging station.

12. The method of claim 11, wherein the authorizing of the delivery of electrical charge comprises:
transmitting, by the EV charging station controller and to the EV charging station, an authorization command via the EV charging station API platform, wherein the authorization command comprises information indicative of vehicle identification, state-of-charge data, and payment credentials.

13. The method of claim 11, further comprising:
receiving, at the EV charging station controller and from the EV charging station, a notification that the EV charging station is delivering electrical charge to the EV via the EV charging station API platform.

14. The method of claim 11, further comprising:
monitoring, by the EV charging station controller, the EV charging transaction based on real-time updates regarding the delivery of electrical charge to the EV by the EV charging station received from the EV charging station API platform.

15. The method of claim 14, further comprising:
causing, by the EV charging station controller, information regarding the EV charging transaction to be displayed via a display module operatively coupled to the EV charging station based on the real-time updates received from the EV charging station API platform.

16. The method of claim 1, wherein the EV charging station controller is configured to communicate with the EV charging station and the EV via a standardized communication protocol.

17. The method of claim 16, further comprising:
establishing, by the EV charging station controller and via the standardized communication protocol, a charging and discharging schedule for the EV and the EV charging station, causing energy flow parameters to be securely exchanged between the EV and the EV charging station, wherein the EV charging station delivers electrical charge to the EV during one or more charging periods of the charging and discharging schedule, and the EV returns electrical charge to the grid during one or more discharging periods of the charging and discharging schedule.

18. An electric vehicle (EV) charging station comprising:
an EV charging station controller configured to control operation of the EV charging station;
a database configured to store EV charging transaction information;
a display module operably coupled to the EV charging station controller and configured to display multimedia content;
one or more charging cables and one or more connectors corresponding to the one or more charging cables configured to deliver electrical charge; and
a point-of-sale (POS) terminal operably coupled to the EV charging station controller and configured to accept payment of a credit card or a debit card,
wherein the EV charging station controller is further configured to:
determine that a charging cable of the one or more charging cables is plugged into an EV;
initiate an EV charging transaction upon receiving an indication of approval of payment for delivery of electrical charge by the EV charging station using the credit card or the debit card via the POS terminal, wherein the approval of the payment is provided at least in part by a financial services provider associated with the credit card or the debit card used for payment via the POS terminal;
in response to receiving the indication of the approval of payment, authorize the delivery of electrical charge by the EV charging station, causing the EV charging station to activate delivery electrical charge to the EV; and
cause the EV charging station to deactivate the delivery of electrical charge to the EV when the EV charging transaction is complete.

19. A method comprising:
determining, by an electric vehicle (EV) charging station controller, that a charging cable of an EV charging station is plugged into an EV, the EV charging station controller being configured to control an operation of the EV charging station;
initiating, by the EV charging station controller, an EV charging transaction upon receiving an indication of approval of payment for delivery of electrical charge by the EV charging station using a loyalty card via a point-of-sale (POS) terminal, wherein the POS terminal is operably coupled to the EV charging station, wherein the loyalty card is associated with customer payment information locally stored in a database of the EV charging station, and wherein the approval of the payment is performed by the EV charging station based on the locally stored customer payment information;
in response to receiving the indication of the approval of payment, authorizing, by the EV charging station controller, the delivery of electrical charge by the EV charging station, causing the EV charging station to activate delivery electrical charge to the EV; and
causing, by the EV charging station controller, the EV charging station to deactivate the delivery of electrical charge to the EV when the EV charging transaction is complete.

20. (canceled)
